(19) United States
(12) Patent Application Publication
(10) Pub. No.: US 2005/0246092 A1
(43) Pub. Date: Nov. 3, 2005

(54) WIRELESS MOBILE ASSET TRACKING VEHICLE

(75) Inventor: RICHARD WILLIAM MOSCATIELLO, DECATUR, GA (US)

Correspondence Address: Mr. RICHARD WILLIAM MOSCATIELLO, 109 KATHRYN AVENUE, DECATUR, GA, 30030-5015, US

(73) Assignee: RICHARD WILLIAM MOSCATIELLO, DECATUR, GA (US)

(21) Appl. No.: 10/906,301

(22) Filed: Feb. 14, 2005

Related U.S. Application Data
(60) Provisional application No. 60/566,349, filed on Apr. 30, 2004.

(51) Int. Cl. G01C 21/00

(52) U.S. Cl. 701/207; 340/539.13

(57) ABSTRACT

A vehicle designed to detect, identify, and establish the location of portable objects in a building or structural space, such as portable medical equipment in a hospital environment, that move from place to place as they are used. The vehicle system provides for automatic detection and correlation of the objects' locations, while the vehicle is propelled within the structural environment, using passive radio frequency transponder technology to detect the presence of tagged objects and tagged fixed locations, basic identification of the object or spatial location replying to the interrogation, and time-stamped correlation of objects and spatial locations. The transmitters and antennae are mounted in the vehicle and are protected from environmental hazards such as pressure washing. An integrated microprocessor performs the requisite algorithms needed to process the reply from one or more Radio Frequency IDentification (RFID) tags, correlates the data and transmits the data, via a wireless RF modem mounted to the vehicle, to a central modem for storage and processing. Rechargeable dry cell or gel batteries power the vehicle's electronics for 24 hours or more, and the vehicle is equipped with an onboard battery charger that can be plugged into a standard AC power socket.

### BACKGROUND OF THE INVENTION

1. Field of the Invention

The present invention relates generally to transponder/reader systems for the tracking of transponder-tagged objects and spaces and, more particularly, to a RFID transponder/vehicle-mounted reader system for the detection and identification of portable objects distributed within a building or structural space and for the storage, transmission, and reporting of information related to the transponder-tagged object. The present embodiment of the invention is a based on concepts described in pending Provisional Application for Patent 60/566,349 filed on Apr. 21, 2004 by Richard Moscatiello on behalf of inventors Robin Dubois and Richard Moscatiello.

2. Description of the Prior Art

Organizations such as hospitals, manufacturing plants, and professional offices use portable objects such as medical equipment, tools, and physical documents that are distributed within the organization's operating environment such as a building, factory, or office complex (i.e., a structural space). Originating from a central distribution point, the portable object is delivered to a specified location in the structural space. However, as a function of its use, the portable object may travel to various different locations in the structural space, for example to a different wing of a hospital. Once the user has completed using the portable object, that object becomes available for use elsewhere within the organization's facility. However, the uncertainty of the portable object's last location makes it difficult to retrieve for redistribution. The result is a high cost of managing the organization's inventory of portable objects. For example, it is time-consuming, labor-intensive, and inefficient to locate portable equipment by manually searching large buildings and structural spaces. Also, in order to meet time-critical demand extra objects may need to be rented from outside suppliers, further increasing cost. Thus, a need exists for an effective system for tracking portable objects within a structural space at low cost.

There are various methods for managing the location of portable objects within a structural space using RFID technology that are fundamentally different from the present invention:

One method is to create a grid of many RFID Interrogators and antennae by positioning them in fixed locations within the structural space. Tagged objects that pass within the range of a fixed Interrogator are identified and time-stamped as having been seen at that location. This option is impractical because of the high cost of individual RFID interrogators and Antennae and the cost of installing coaxial cabling to the antennae in a large structural space. Increasing positional accuracy requires the addition of more RFID interrogators.

Another method is to fit RFID Interrogators with at least two directional antennae that are positioned on the outer boundaries of the structural space. Portable objects fitted with Active (i.e., battery powered) RFID Transponders are then detected and located within the structural space using RF triangulation techniques. In order for the RF to penetrate obstructions such as walls and structural elements, the RF is preferably in the approximate range of 300 MHz to 500 MHz. However, current RFID industry standards in development for supply chain and asset management applications identify the 902 MHz to 928 MHz band as ideal. Although the Active Transponders have a longer RF detection range, they are not as small and inconspicuous as passive transponders, are more expensive, and require maintenance.

Definition List 1

| Term | Definition |
|---|---|
| RF | Radio Frequency; a tuned, oscillating field |
| | of electromagnetic radiation generated for |
| | the purpose of communicating information. |
| RFID | Radio Frequency Identification; a method of |
| | acquiring data over a modulated |
| | electromagnetic field carrier wave, tuned to |
| | a specified band of frequencies, by |
| | imparting a reflection of the source field |
| | radiation back to the transmitter in |
| | sequences that are interpreted as |
| | information in the form of digital data. |
| Interrogator | An electronic instrument that generates |
| | modulated radio frequencies for |
| | transmitting and receiving RFID data. |
| RFID transponder | (Also called RFID tag, transponder tag, tag) |
| | A miniaturized electrical assembly |
| | comprising an integrated circuit (IC) chip |
| | mated to a small antenna, the purpose of |
| | which is to communicate digital data stored |
| | in the IC chip to an RFID Interrogator. |
| Active | In the context of RFID, a transponder that is |
| | powered by a small battery. |
| Passive | In the context of RFID, a transponder |
| | powered by energy drawn from the RF |
| | carrier wave transmitted by the |
| | interrogator. |
| Tagged | Having attached an RFID transponder to an |
| | object or location. |
| Structural space | A two-dimensional area or three- |
| | dimensional volume having fixed |
| | boundaries defined by fences, walls, |
| | ceilings, floors, floor plans, rooms, entry |
| | and exit points, pathways, cubicles, grids, |
| | pillars, or other physical, structural |
| | elements. Examples include, but are not |
| | limited to, hospitals, multi-story buildings, |
| | factories, campuses, habitable areas, |
| | warehouses, office complexes, etc. |
| Vehicle | In the context of this invention, an |
| | assembly consisting of a mobile conveyance |
| | (assumable wheeled) that has been fitted |
| | with an RFID reader, at least one antenna, a |
| | computer data processor, and a |
| | rechargeable power source, said assembly |
| | operating as a system capable of detecting |
| | and identifying RFID transponders in a |
| | structural space. The system assembly may |
| | also include a radio modem for wireless |
| | data communication. |
| Time-stamp | A relative record of the current real time |
| | that a tag is detected; stored with the tag |
| | identifier in a database. Format: year, |
| | month, day, hour, minute, second, sub- |
| | second. |
| Reader | An RFID Interrogator |

### SUMMARY OF THE INVENTION

The present invention is directed to a system of transponder tags/vehicle-mounted reader for detecting, identifying, and locating portable objects in a structural space with respect to time.

Preferably, the present invention uses passive RFID transponder tags with a vehicle-mounted reader for the detection, identification, and the locating of portable objects in a structural space with respect to time.

The present invention is further directed to a system of object identification to provide detailed information pertaining to the tagged portable object or tagged fixed location.

The present invention is further directed to a method for the management of an inventory of portable objects within a structural space.

Thus, the present invention provides a system of passive RFID transponder tags and vehicle-mounted RFID Interrogator for detecting, identifying, and locating portable objects within a structural space with respect to time.

These and other aspects of the present invention will become apparent to those skilled in the art after a reading of the following description of the preferred embodiment when considered with the drawings.

### BRIEF DESCRIPTION OF THE DRAWINGS

FIG. 1 is a diagrammatic view of a transponder/vehicle-mounted reader system for the detection, identification, and location of portable objects within a structural space with respect to time, constructed according to the present invention.

FIG. 2 is a flow chart describing how the system determines the identity and location of portable objects according to an embodiment of the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

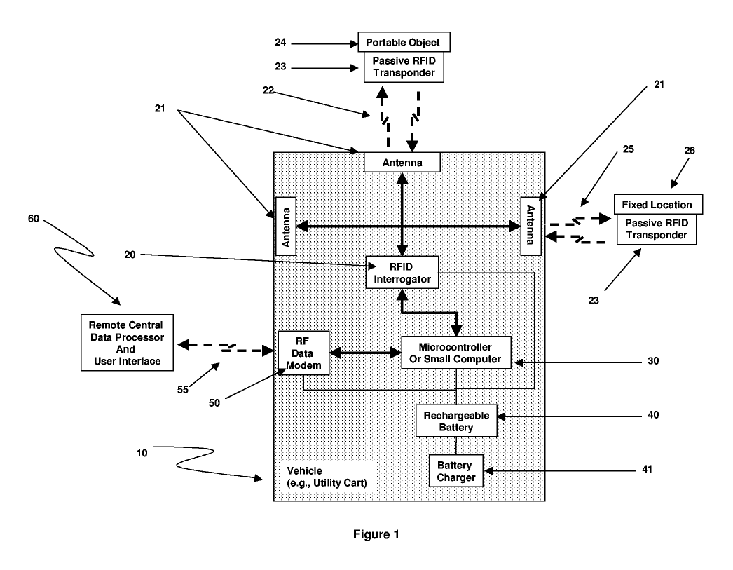

Referring now to the drawings in general, the illustrations are for the purpose of describing a preferred embodiment of the invention and are not intended to limit the invention thereto. As best seen in FIG. 1, the vehicle-mounted RF transponder location system includes a vehicle (such as a utility cart or other mobile platform), generally described as 10, on which is mounted an RF interrogator 20 connected to at least one antenna 21, a vehicle-mounted computer or microprocessor 30, a rechargeable battery 40, battery charger 41, and a Radio Frequency Data Modem 50 in discontinuous radio frequency communication 55 with a Remote Central Data Processor and User Interface 60. The vehicle-mounted RF reader/transponder location system's RFID Interrogator 20, connected to a least one antenna 21, establishes discontinuous radio frequency communication 22 with any RFID transponder 23 mounted to a portable object 24 that randomly comes within range of at least one of the RFID Interrogator's antennae 21. Likewise, the vehicle-mounted RF reader/transponder location system's RFID Interrogator 20, establishes discontinuous radio frequency communication 25 with any RFID transponder 23 mounted to a Fixed Location 26 that randomly comes within range of at least one of the RFID Interrogator's antennae 21.

The function of the transponder 23 is to communicate data that identifies, directly or by means of a relational database, a Portable Object or Fixed Object. More particularly, the transponder 23 is preferably a passive Radio Frequency Identification (RFID) transponder. A passive transponder requires no battery and contains integrated non-volatile memory that allows data to be written to and read from individual tags. The transponder tag can be programmed with any type of data desired within the size constraint of the memory. This programming may be done in the field at installation or prior to installation. The description of the tagged portable object may include the nature of the equipment (or document) tagged, ownership, the responsible service provider, and other information. Thus, the transponder may be pre-programmed with information such as the standard Electronic Product Code (EPC) of the portable object 24 being tracked, description of the tagged object, maintenance dates, test results, and the like. Information pre-programmed into tags attached to Fixed Locations 26 may be the building floor and room number, or a designation relative to a 2-dimensional or 3-dimensional grid. In the preferred embodiment or best mode, the type of data stored in a tag is virtually unlimited. However, there are limitations of the transponder's memory capacity and storing detailed portable object records elsewhere in a relational database can supercede the extra processes and risks involved in frequently updating RFID transponder memory. It is expected that the memory capacity will increase as the technology matures; as such the scope of the present invention is intended to include such memory capacity increases. Although a one-time pre-programming of RFID transponders with relevant data at installation is the preferred option, it is not necessary to have any user programming performed for the system to work, as each transponder is factory programmed with a unique identification (ID) number, which is all that is needed for positive detection and identification when the unique ID is associated with a record stored in a relational database resident in the vehicle-mounted computer 30 or transmitted 55 via the RF Data Modem 50 to a relational database resident in a Remote Central Data Processor 60.

Conditions that may adversely affect the detection range of the system include the following: RF signal polarization, RF reflections, water, metal, contact surfaces, and shielding. Preferably, the following considerations are recommended to ensure proper functioning of the system according to the present invention.

Polarization: The tags and reader antenna should be oriented correctly. Also, other antenna techniques such as circular polarization could be employed if required.

Water: The wetter the environment, the more the RF signal will be attenuated;

Contact surfaces: The tags cannot be placed directly against metal;

Shielding: Metal structures will shield the tags and impair detection. Preferably, tags must be located at least 21 millimeters in front of any metal surface on an object with respect to the antenna line-of-sight to achieve detection.

Other characteristics of the transponder that may affect the response time will include the minimum input power level for activation, the inherent delay of the transponder circuitry, and the effect of temperature, humidity, RF interference and other environmental conditions on the transponder. Characteristics of the vehicle-mounted components of the system that affect the response time include the interrogatory signal power level of the RFID Interrogator 20, the signal power level of the Transponder 23, the detection threshold of the RFID interrogator 20, and the gain of the antennae 21.

Because the transponder is preferably a passive transponder, the lower the input energy required by it to generate a detectable response signal, the farther the detection range it will have. Therefore, it is desirable that the transponder operate at frequencies that are less susceptible to environmental interference and thus require less power to achieve a given range. This frequency range is preferably between about 13.5 MHz and 2.45 GHz, more preferably about 915 MHz. The FCC has set aside a band of frequencies from 902-928 MHz for various purposes. The 915 MHz system according to the present invention falls into the spread-spectrum application defined in Part 15 of the FCC regulations. The performance of the tags and the reader at approximately 915 MHz allows for smaller antenna geometry and offsets the relative reduction in penetrating ability. Among the hardware available in the RFID industry today the most appropriate technologies for this application use 915 MHz as the operating frequency. The at least one antenna can be a single antenna or multiple antennae. In the case of use of any single antenna, it can be a circularly polarized antenna, an omni-directional antenna, unidirectional antenna, or a directional antenna, such as a dipole antenna or Yagi antenna, for increased directionality and range.

The vehicle-mounted RFID transponder detection system (hereafter referred to as the “vehicle”) interrogates the surrounding 3-dimensional space for tags a multiplicity of times per predetermined period; for the present invention embodiment, the surrounding area or transponder vicinity is interrogated approximately 400 times per second. On average, the equipment needs to reliably record a target at a range of up to 10 feet. The testing that was done showed the equipment constructed and configured according to the present invention was capable of meeting this performance standard.

The following hypothetical scenario is given to illustrate how the vehicle may be used in a practical application. In the scenario, locations described as ‘Central Distribution,’ ‘First Floor Elevator Door,’ ‘Sixth Floor Elevator Door,’ ‘Room 605,’ ‘Room 632,’ etcetera are speculative and are used for the sole purpose of describing a preferred embodiment of the invention. The following description is not intended to limit the invention thereto. The RFID Interrogator vehicle's associated function is as a conveyance to transport and distribute portable objects to locations within the structural space. The portable objects are introduced into the system environment from a ‘Central Distribution’ point. The ‘Central Distribution’ area's walls, ceiling, or other fixed structure are affixed with location tags that are within range of the vehicle. The vehicle detects at least one of those tags to establish its present location and stores that datum. At ‘Central Distribution’ tagged portable objects are placed on the vehicle, which immediately detects and identifies the object tags and generates a list of tagged objects that it associates with its present location at that time. As the vehicle is wheeled out of the ‘Central Distribution’ area with its cargo of portable objects, the ‘Central Distribution’ location tags are no longer detected, although the vehicle still detects the objects. Thereby the vehicle software “reasons” that it has left the ‘Central Distribution’ area and is in transit with the cargo of portable objects. As the vehicle approaches the ‘First Floor Elevator Door’ it identifies a location tag there and updates its list of objects as having been seen near the first floor elevator at that time. The vehicle is wheeled into the elevator and gets off on the sixth floor. As it passes through the ‘Sixth Floor Elevator Door’ the vehicle identifies the sixth floor elevator tag and updates its object list as being at the sixth floor elevator stop. On the sixth floor the vehicle identifies a tag as ‘Room 605.’ As the vehicle moves away from ‘Room 605,’ it detects that an object previously on the vehicle is no longer present. Because the vehicle last detected the object when it was at ‘Room 605,’ the vehicle software “reasons” that the object was delivered to that location. As the vehicle continues along it briefly detects a tagged object that it passes in the hallway. That object is identified, time stamped, and added to the object list. As the vehicle passes the location tag at ‘Room 632’ it updates the record of the object that it passed in the hallway as located between ‘Room 605’ and ‘Room 632.’ Thus, while the RFID vehicle is used as a conveyance for the distribution of portable objects, it creates a continuously updated database that maps in real time the location of portable objects within the structural space.

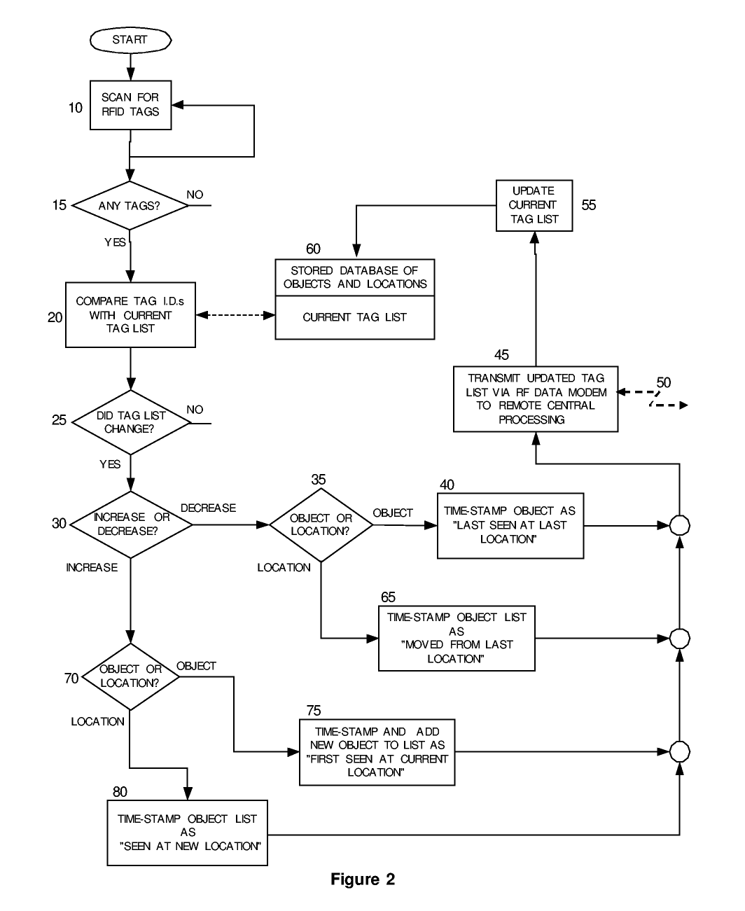

As a further visualization of the above, FIG. 2 depicts a software flowchart or application algorithm that illustrates how the RFID vehicle automatically detects, identifies, and time-stamps the location of tagged portable objects, and creates and updates a database that maps in real time the location of the tagged portable objects. The database can be stored on the vehicle for later upload to a Remote Central Data Processor and User Interface via a hard data connection and, if fitted with a radio data modem, can transmit database updates in near real time. After the vehicle system performs its power-on routines, it activates the RFID Interrogator and continuously scans the surrounding space for RFID tags 10. When the systems detects tags 15, it generates a list of tag identities and compares the tag identities 20 with the most recently updated Current Tag List stored in the Database of Objects and Locations 60. If the comparison shows that the tag Lists are the same 25, no action is taken and the system continues to process tag identities as they are detected 10, 15, 20. If the comparison yields a difference between the incoming tag identities and the Current Tag List 60, the system decides whether tags have been subtracted or added 30. If fewer tags have been detected the missing tag(s) are classified as being an object identity or a location identity 35. If objects have been removed, the objects' identifiers are time-stamped and flagged as “Last Seen at Last Location” 40. If the tag is a Location identity 35 the software “reasons” that the vehicle has moved away from it's last location and therefore time-stamps the object list as “Moved From Last Location” 65. Similarly, if more tags have been detected the added tag(s) are classified as being an object identity or a location identity 70. If objects have been added, the objects' identifiers are time-stamped and flagged as “First Seen at Current Location” 75. If the tag is a Location identity 70 the software “reasons” that the vehicle is near to a new location and therefore time-stamps the object list as “Seen at New Location” 80. Newly updated tag lists (40, 65, 75, 80) are transmitted 50 via the RF Data Modem 45 to Remote Central Processing, where it becomes available for User Interface Reporting. The newly updated tag list is written into Database of Objects and Locations memory 60 as the Current Tag List. The Database of Objects and Locations 60 stores a historical record of all previously updated Current Tag Lists for review and reporting.

1. A vehicular methodology for establishing the location of portable objects within a building or structural space with respect to time, including:
Operating a vehicle fitted with an RFID transponder detection system within a building or structural space, said vehicle being used in the distribution and collection of portable objects or equipment in the building or space, that in the course of its use automatically detects, identifies, and establishes the location of portable objects within said building or space;
Programming passive RFID transponders with location data at installation;
Tagging portable objects and fixed structural locations with preprogrammed passive RFID transponders for the purpose of correlating portable objects with fixed structural locations;
Detecting, identifying, and differentiating transponders as either a portable object or a fixed location;
Detecting and identifying transponders attached to fixed locations in order to establish the current location of a vehicle fitted with an RFID transponder detection system;
Detecting and identifying transponders attached to portable objects and correlating the portable objects with fixed locations;
Recording in a data base the identification, location, and time of identification at that location of portable objects detected within the building or structural space;
Presenting said database in a human-readable format that identifies the location of portable objects for the purpose of retrieval, collection, service, maintenance, return, transfer, redistribution, or other reason, of the portable objects within the structural space.

2. The method according to claim 1, further including the step of programming the RFID transponders at installation.
